(19) United States
(12) Patent Application Publication
(10) Pub. No.: US 2026/0266390 A1
(43) Pub. Date: Sep. 10, 2026

(54) VALVE UPPER PART FOR SANITARY FITTINGS

(71) Applicant: Flühs Drehtechnik GmbH, Lüdenscheid (DE)

(72) Inventors: Lutz LANGE, Lüdenscheid (DE); Stefan ROICKE, Herscheid (DE)

(73) Assignee: Flühs Drehtechnik GmbH, Lüdenscheid (DE)

(21) Appl. No.: 19/163,444

(22) PCT Filed: Feb. 8, 2024
(86) PCT No.: PCT/EP2024/053242

§ 371 Date: Sep. 9, 2025

(30) Foreign Application Priority Data
Mar. 10, 2023 (EP) 23161218.5

(51) Int. Cl. F16K 31/528; F16K 31/52

(52) U.S. Cl. CPC F16K 31/5286; F16K 31/523

(57) ABSTRACT

A valve upper part includes a head piece which is axially penetrated by a control spindle by which a valve body arranged in the head piece can be actuated, and an operating part including a handle, wherein the handle can be displaced relative to the head piece coaxially to the control spindle, wherein the handle is connected to the control spindle by an adapter piece fastened to the handle in a rotationally fixed manner, and wherein the adapter piece has an inner thread which is in engagement with an outer thread of the control spindle or with a component connected to the control spindle and by which its axial position relative to the control spindle can be changed by rotation.

The invention relates to a valve upper part with a head piece, which is axially penetrated by a control spindle, by means of which a valve body arranged in the head piece is actuatable and which is connected to an operating part comprising a handle, wherein the handle is movable relative to the head piece coaxially to the control spindle.

By means of valve upper parts, the discharge of media from fittings is controlled. For this purpose, the valve upper part is screwed by means of its head piece into the housing of a fitting. Valve upper parts of the aforementioned type are known in a wide variety of configurations. Thus, for example, a valve upper part is known from EP 3 062 002 A1, which has a head piece penetrated by a spindle which, in the head piece, is interlockingly connected to a control disk, which abuts an inlet disk, which is fixed in place. By rotating the control disk relative to the inlet disk, control of the water flow is achieved. For actuating the spindle, the spindle is designed on the outside as an external polygon on its end face projecting out of the head piece and, on the inside, is provided with a threaded blind hole for the interlocking fastening of a rotary handle.

Moreover, a valve upper part is known from EP 2 522 887 A1 , in which, for controlling the flow of a fluid, a valve body is provided, which is linearly movable within the head piece via a spindle. In this case, a spindle is rotatably mounted in a head piece and is connected via a thread to a rotationally fixed valve body, which is axially guided in the head piece. A rotation of the spindle thus brings about an axial movement of the valve body within the head piece.

With fittings, there is an increasing demand for operation of the valve upper part using push-pieces or push-buttons. Electromagnetically operated valves are regularly used for this purpose. A disadvantage of these valve upper parts, however, is that the electromagnetic contacts can be affected during the screwing and bonding of the valve upper part, as a result of which the reliability is impaired. Furthermore, such valves require an additional voltage source. In addition, quantity control is generally not possible with these valves.

In order to overcome these disadvantages, EP 3 366 959 A1 relates to a valve upper part in which the handle has is a control cap, with which it is movable along the head piece and via which a control piston is actuatable, wherein a curved path having two locking positions is introduced on the outside into the lateral surface of the head piece, into which a guide pin arranged on the control cap engages. By means of a pressure actuation of the handle with the control cap, a guided axial movement of the control piston is achieved, which is lockable in at least two positions, for example, in the positions “valve open” and “valve closed.”

In the design of fittings, a certain axial positioning of the operating part of a valve with a spindle, in particular of such a push valve, is often desired, which is to lie, for example, in a plane with the level underlying surface surrounding this. In practice, such designs prove to be difficult, however. During the mounting of such a valve upper part, an extra-long control spindle is usually used, which, after installation, is cut to a desired length. For this purpose, the control spindle regularly has an arrangement of uniformly spaced-apart separating notches. Inaccuracies during the installation of the valve upper part and the cutting of the control spindle to length frequently result in deviations in the axial position of the operating part after its mounting, as a result of which the overall visual appearance of the fitting is impaired. Such positioning errors frequently require much effort to correct.

This is where the present invention comes in. The problem addressed by the invention is that of providing a valve upper part for sanitary fittings, in which the axial positioning of an operating part connected to its control spindle is simplified. According to the invention, this problem is solved by a valve upper part having the features of Patent Claim 1.

The invention provides a valve upper part for sanitary fittings, in which the axial positioning of an operating part connected to its control spindle is simplified. Due to the fact that the handle is connected, via an adapter piece fastened to this for conjoint rotation, to the control spindle, wherein the adapter piece has an internal thread, which is in engagement with an external thread of the control spindle or a component connected to the control spindle and via which its axial position relative to the control spindle is changeable by rotating, a fine adjustment of the axial position of the handle on the spindle of a valve upper part installed in a wall is made possible. Rotating the handle in an adjusting position brings about a longitudinal adjustment of the adapter piece along the external thread of the control spindle or of a component connected to the control spindle. Inaccuracies during the installation of a valve upper part and the cutting of the control spindle to length, according to demand, which is usually carried out in this course, can thus be compensated by moving by adapter piece.

In a development of the invention, the handle of the operating part has an adjusting sleeve, in which the adapter piece is arranged and connected thereto for conjoint rotation. The adapter piece is preferably held in the adjusting sleeve of the handle in a rotationally fixed and longitudinally displaceable manner.

In a development of the invention, the internal thread of the adapter piece is in engagement with an external thread arranged on a control cylinder, which accommodates a control piston, which is connected to the control spindle.

In an embodiment of the invention, the handle is fixable in at least two axial positions via an arranged locking device. The locking device is preferably arranged in the operating part and comprises the control piston, which is axially movably guided in the control cylinder, wherein the control cylinder has a control gate into which an engagement part arranged on the control cylinder engages. As a result, the locking device operates between the control piston and the control cylinder arranged in the adjusting sleeve.

In an embodiment of the invention, the engagement part is formed by a ball, which is guided in the control cylinder in a radially and rotatingly movable manner. As a result, a rotation of the handle, when actuated, induced by the balls is avoided. As compared to the guide pins known from the prior art, the balls also have the advantage that occasional malfunctions resulting from guide pins or their guides having been deformed due to overloading are avoided.

In a further development of the invention, the handle of the operating part has an adjusting sleeve in which the adapter piece is arranged and connected to this for conjoint rotation and which preferably surrounds the control piston, at least in some areas. As a result, the handle is guided along the control piston, wherein the locking device operates between the control piston and the control cylinder arranged in the adjusting sleeve. For arranging a ball in a radially and rotatingly movable manner, which engages into the control gate of the control piston, this can be arranged in a cage arranged on the control cylinder. Preferably, the control piston has a non-circular outer cross-section and the control cylinder has an inner cross-section corresponding to this outer cross-section, as a result of which the control piston is guided in the control cylinder in a rotationally fixed but movable manner.

In a development of the invention, a spring is arranged between the control cylinder and the control piston, which is preloaded against the control cylinder. As a result, an automatic return of the control cylinder, which is connected to the handle, along the control piston after application of an actuating force is brought about.

In an embodiment of the invention, the adapter piece is held in the adjusting sleeve of the handle in a rotationally fixed and longitudinally displaceable manner. The adjusting sleeve preferably has an internal toothing, which engages into an external toothing arranged on the control piston, as a result of which the handle is movably guided axially along the control piston. As a result, a corotational connection of the adjusting sleeve to the control piston is achieved in combination with a simultaneous ability to move axially.

In a further embodiment, the adapter piece has snap-in lugs, wherein at least one snap-in groove is arranged inside of the adjusting sleeve, into which the snap-in lugs are capable of snapping when the adapter piece is in a defined position. As a result, a defined axial positioning of the adapter piece in the adjusting sleeve is made possible, in which its internal toothing is not in engagement with the external toothing of the control piston (adjusting position).

Preferably, at least two snap-in grooves are preferably radially peripherally arranged inside of the adjusting sleeve, axially spaced apart from one another. As a result, a first axial positioning of the adapter piece for the adjustment and a second defined positioning of the adapter piece in the operating position with engagement of its internal toothing in the external toothing of the control piston are made possible.

In a development of the invention, the control spindle has a non-circular connecting portion, wherein a receptacle for the interlocking connection to this non-circular connecting portion, which is preferably detachably connected to the control spindle, is arranged on the control piston. Alternatively, the receptacle and the connecting portion can also be cylindrical and bonded to one another or connected to one another via other connecting means. As a result, a transmission of a torque from the handle onto the control piston and the control spindle connected thereto is made possible. By pressing on the handle, this can be moved out of a retracted position via the locking device, after which the valve upper part can be actuated by turning the handle.

In one embodiment, in which both the adjusting device formed by the adapter piece and the locking device are arranged in the operating part, the control piston of which is detachably connectable to the control spindle, a simple replacement of the operating device and a simple retrofitting of a valve upper part with such an operating device is made possible. The only prerequisite is that the particular valve upper part have a spindle, via the rotation of which a valve body is actuated.

In a further embodiment of the invention, an installation sleeve is arranged, the inner diameter of which essentially corresponds to the outer diameter of the handle of the operating part, wherein the position of the handle is settable at a defined distance from the installation sleeve. Preferably, the installation sleeve has a peripheral collar, which forms a common plane with the surface of the handle when the handle is positioned in a defined position in the installation sleeve. As a result, an optically pleasing integration of the handle into a plane surrounding this is made possible. The collar can be both annular and also designed in the form of a plate having any geometric shape.

The object of the present invention is also an operating part for a valve upper part of Claim 14 and a sanitary fitting with a valve upper part for sanitary fittings of one of Patent Claims 1 through 13.

The adjusting position is understood in the present case to be the position of the handle, in which the snap-in lugs of the adapter piece engage into the second, lower snap-in groove in the adjusting sleeve. In this position, an adjustment via the threaded engagement between the external thread of the control cylinder and the internal thread of the adapter piece is made possible. The internal toothing of the adjusting sleeve is out of engagement with the external toothing of the control piston.

The operating position is understood in the present case to be the position of the handle, in which the snap-in lugs of the adapter piece engage into the first, upper snap-in groove in the adjusting sleeve. In this position, the internal toothing of the adjusting sleeve is in engagement with the external toothing of the control piston. An adjustment via the threaded engagement between the external thread of the control cylinder and the internal thread of the adapter piece is not possible.

The operating position is understood in the present case to be the position of the handle, in which the balls lie in the upper position of the control gate. The handle is thus “extended” for simple operation.

The retracted position is understood in the present case to be the position of the handle, in which the balls lie in the holding region of the control gate. Here, the handle is locked in a retracted position in which, for example, the handle is flush with surroundings enclosing this handle.

Other developments and embodiments of the invention are disclosed in the remaining dependent claims. Exemplary embodiments are shown in the drawings and are described in detail in the following. Wherein:

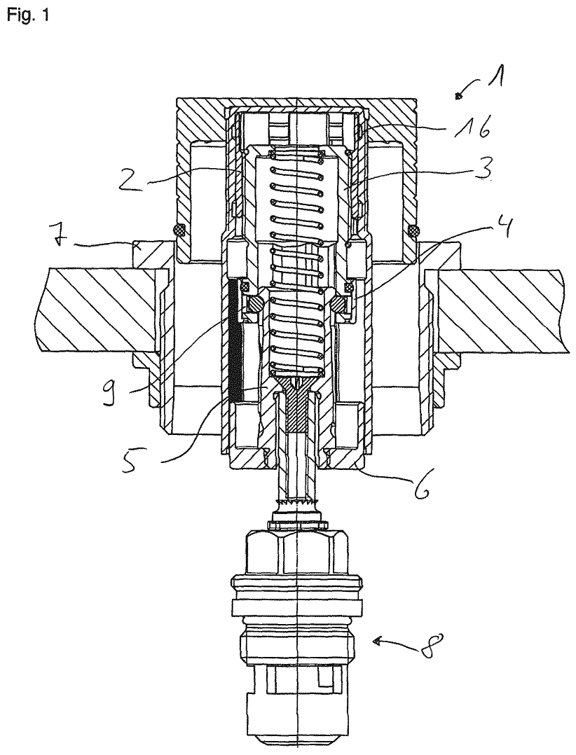

FIG. 1: shows the schematic view of a valve upper part with an operating device after a basic mounting with the handle in the operating position;

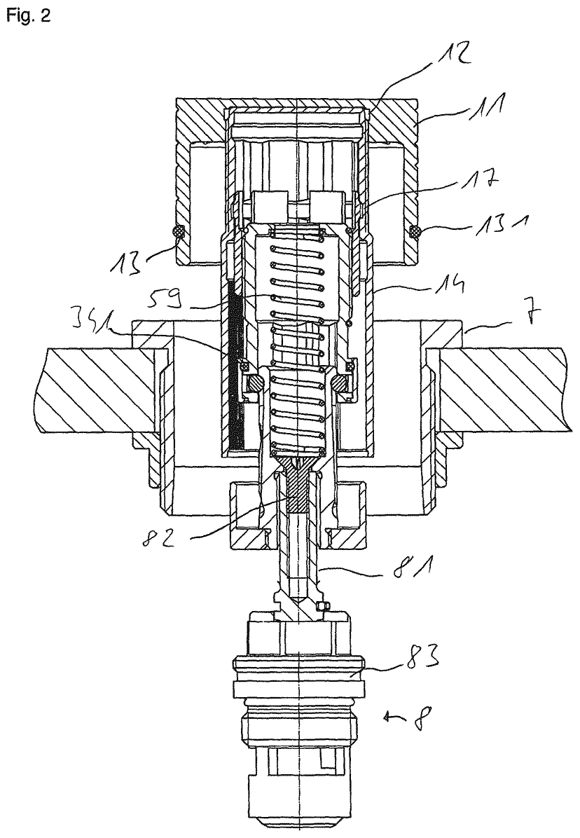

FIG. 2: shows the schematic view of the valve upper part with the operating device according to FIG. 1 with the handle in the adjusting position (prior to an adjustment);

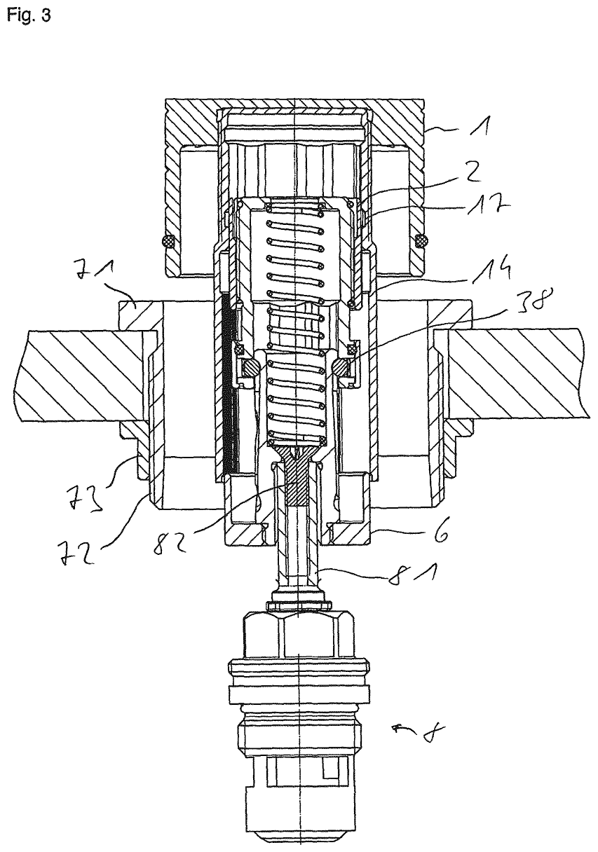

FIG. 3: shows the schematic view of the valve upper part with the operating device according to FIG. 2 after the handle has been adjusted;

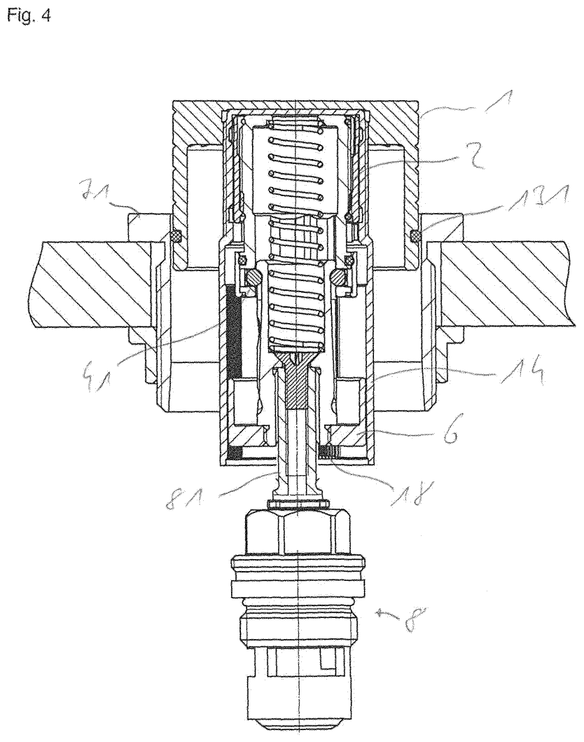

FIG. 4: shows the schematic view of the valve upper part with the operating device according to FIG. 3 with the handle in the operating position;

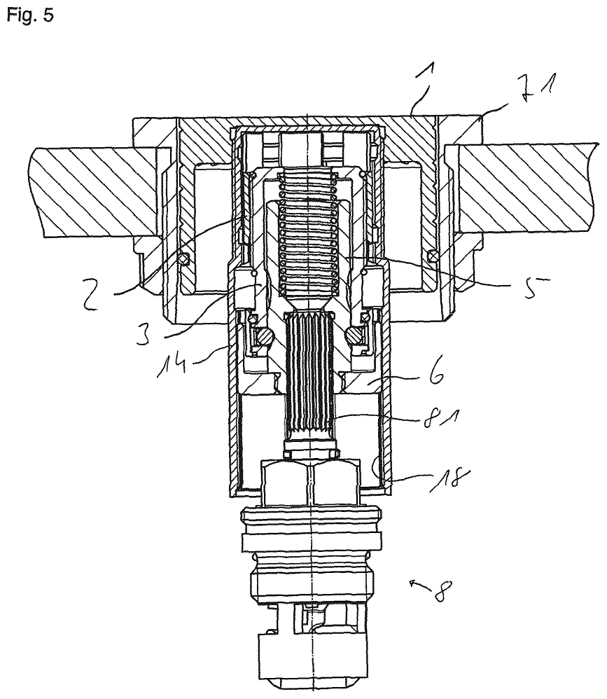

FIG. 5: shows the view of the valve upper part with the operating device from FIG. 4 with the handle in the retracted position;

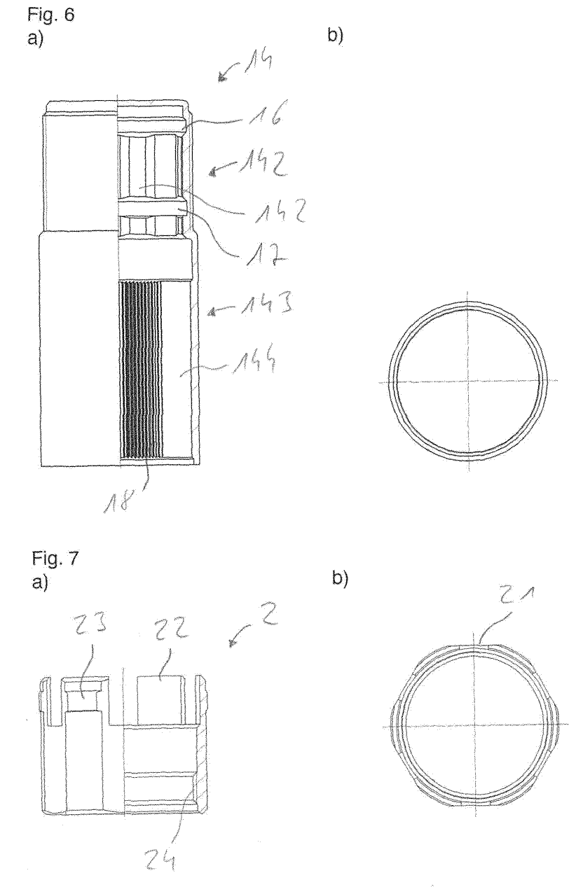

FIG. 6: shows the schematic view of the adjusting sleeve of the handle of the operating device from FIG. 1
a) in the partial section,
b) in the top view;

FIG. 7: shows the schematic view of the adapter piece of the operating device from FIG. 1
a) in the partial section,
b) in the top view;

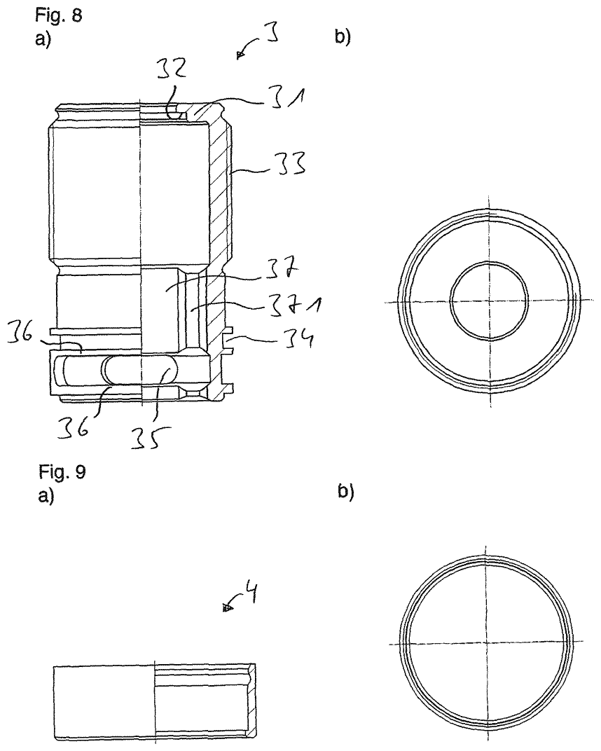

FIG. 8: shows the schematic view of the control cylinder of the operating device from FIG. 1
a) in the partial section,
b) in the top view;

FIG. 9: shows the schematic view of the limiting sleeve of the control cylinder of the operating device from FIG. 1
a) in the partial section,
b) in the top view;

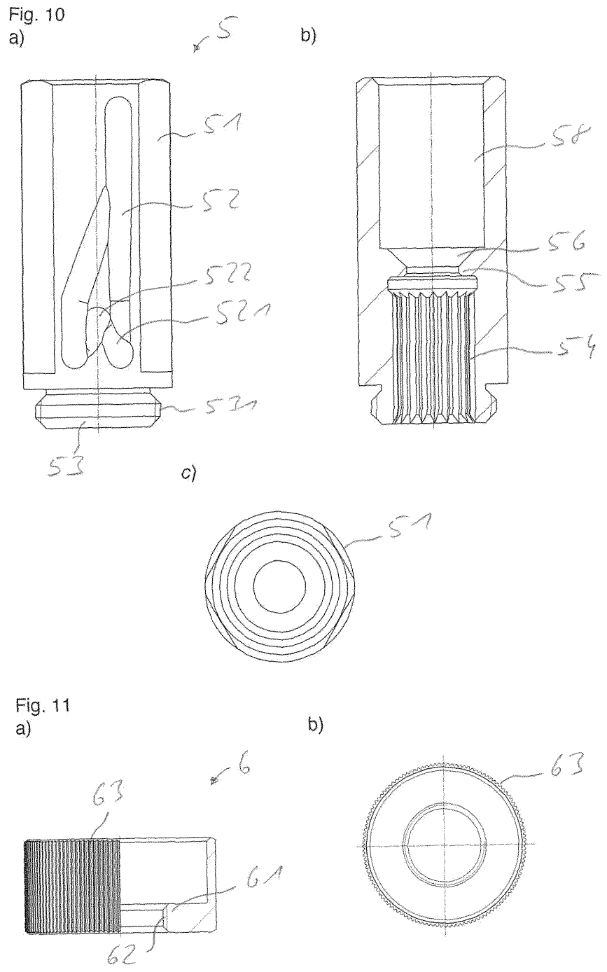

FIG. 10: shows the schematic view of the control piston of the operating device from FIG. 1
a) in the side view;
b) in the longitudinal section;
c) in the top view;

FIG. 11: shows the schematic view of the driving piece of the control piston of the operating device from FIG. 1
a) in the partial section,
b) in the top view.

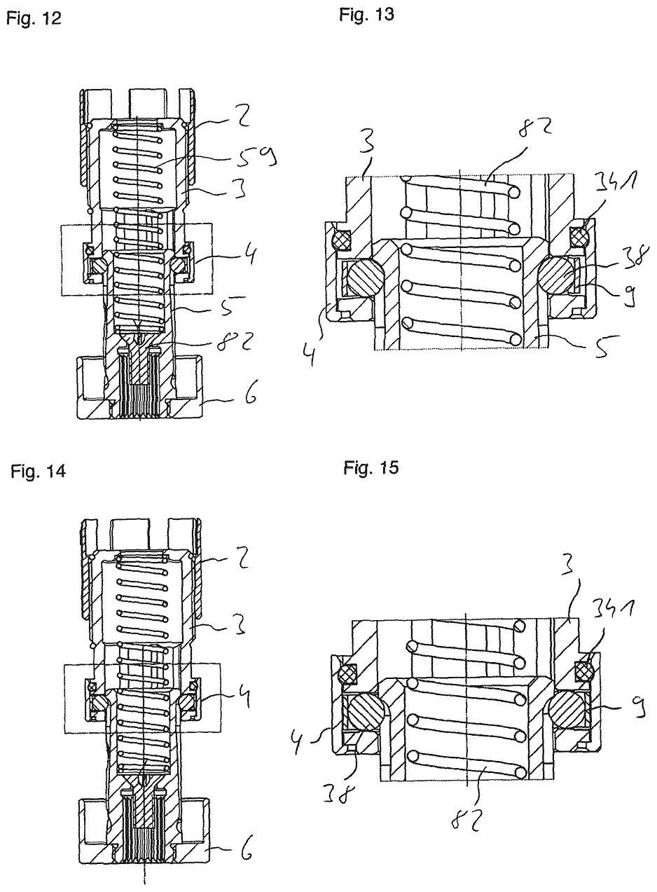

FIG. 12: shows the schematic view of the operating device (without handle) from FIG. 3 in the operating position

FIG. 13: shows the detailed view of the ball cage of the operating device from FIG. 12;

FIG. 14: shows the view of the operating device from FIG. 12 with an elevated tensile load on the control cylinder;

FIG. 15: shows the detailed view of the ball cage of the operating device from FIG. 14;

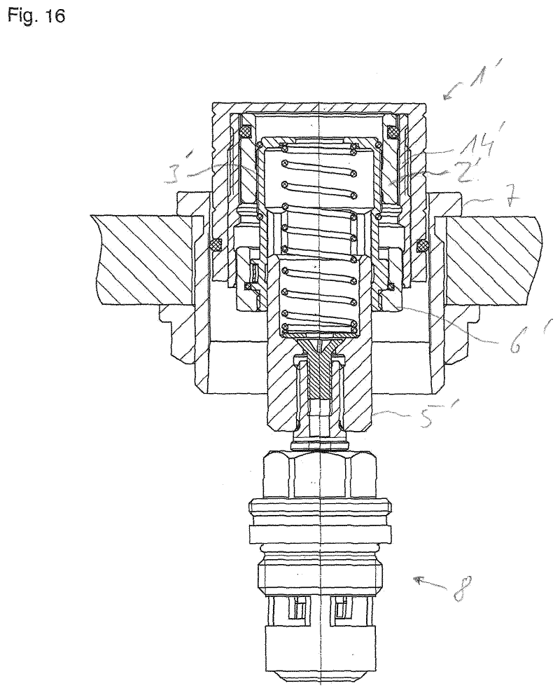

FIG. 16 shows the schematic view of a valve upper part with the operating device in a further embodiment with the handle in the operating position;

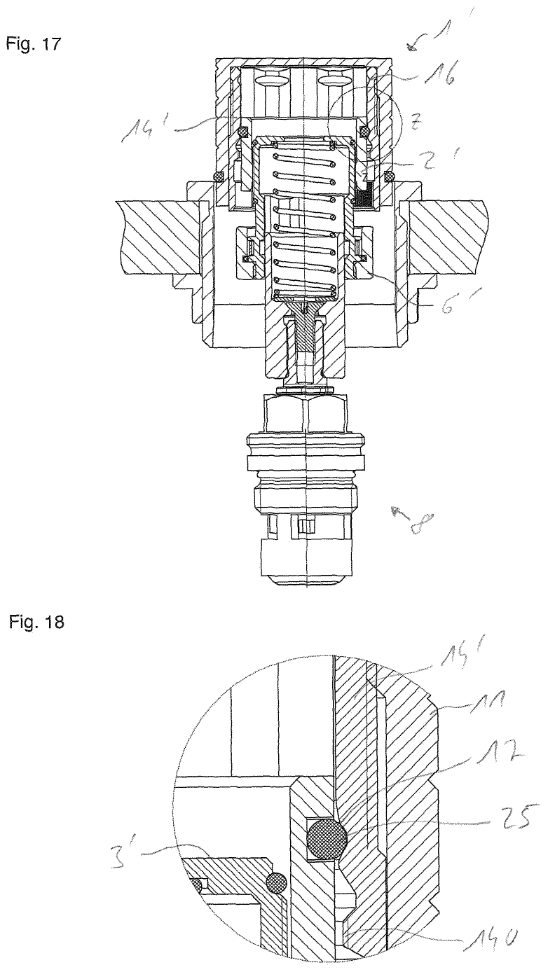

FIG. 17 shows the schematic view of the valve upper part with the operating device according to FIG. 16 with the handle in the adjusting position;

FIG. 18 shows the detailed view of the detail Z from FIG. 17;

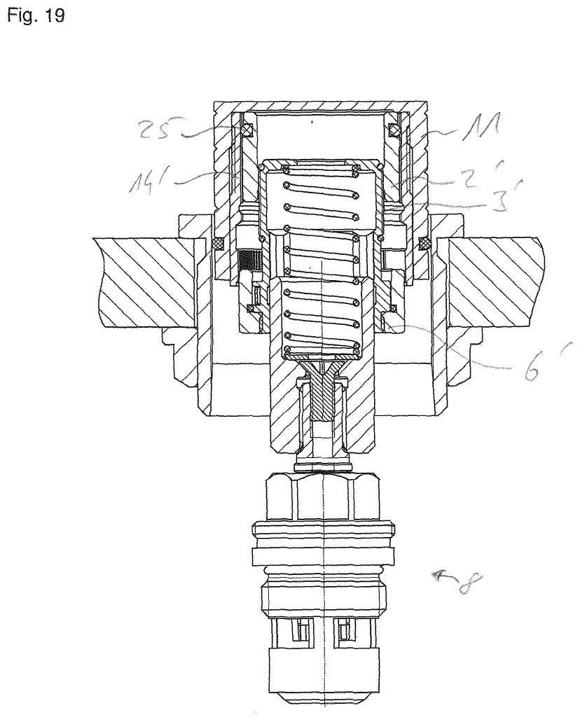

FIG. 19 shows the schematic view of the valve upper part with the operating device according to FIG. 16 with the handle adjustment in the maximum height setting:

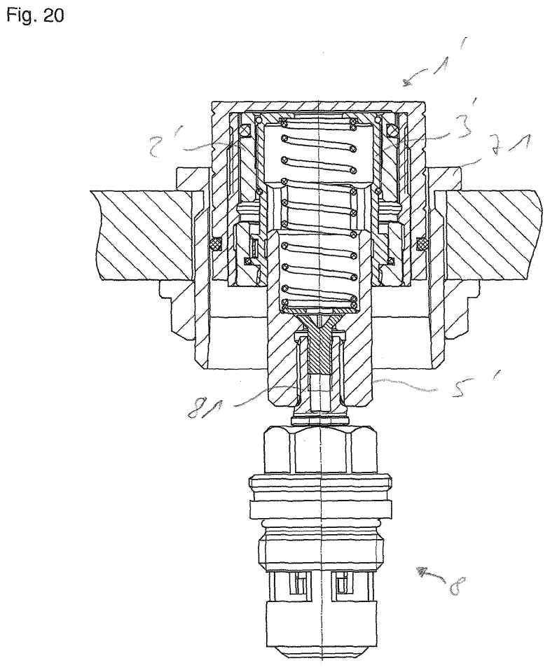

FIG. 20 shows the schematic view of the valve upper part with the operating device according to FIG. 16 with the handle adjustment in the minimum height setting;

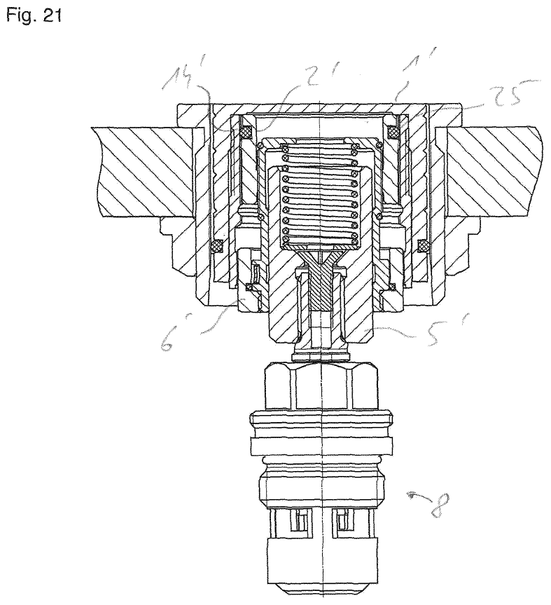

FIG. 21 shows the schematic view of the valve upper part with the operating device according to FIG. 16 with the handle in the pressed-down position;

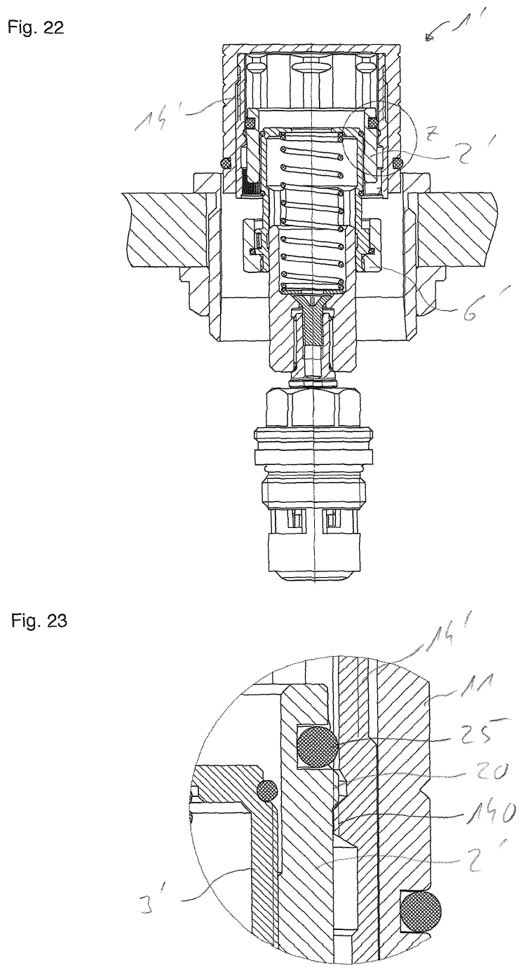

FIG. 22 shows the schematic view of the valve upper part with the operating device according to FIG. 16 with the handle in the withdrawal prevention position;

FIG. 23 shows the detailed view of the detail Z from FIG. 22;

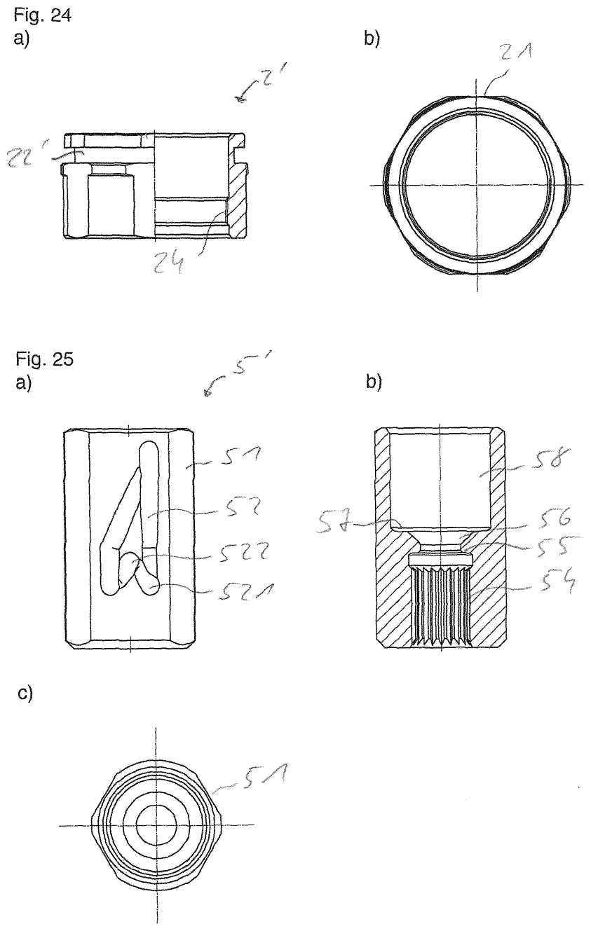

FIG. 24 shows the schematic view of the adapter piece of the operating device from FIG. 16
a) in the partial section,
b) in the top view;

FIG. 25 shows the schematic view of the control piston of the operating device from FIG. 16
a) in the side view;
b) in the longitudinal section;
c) in the top view;

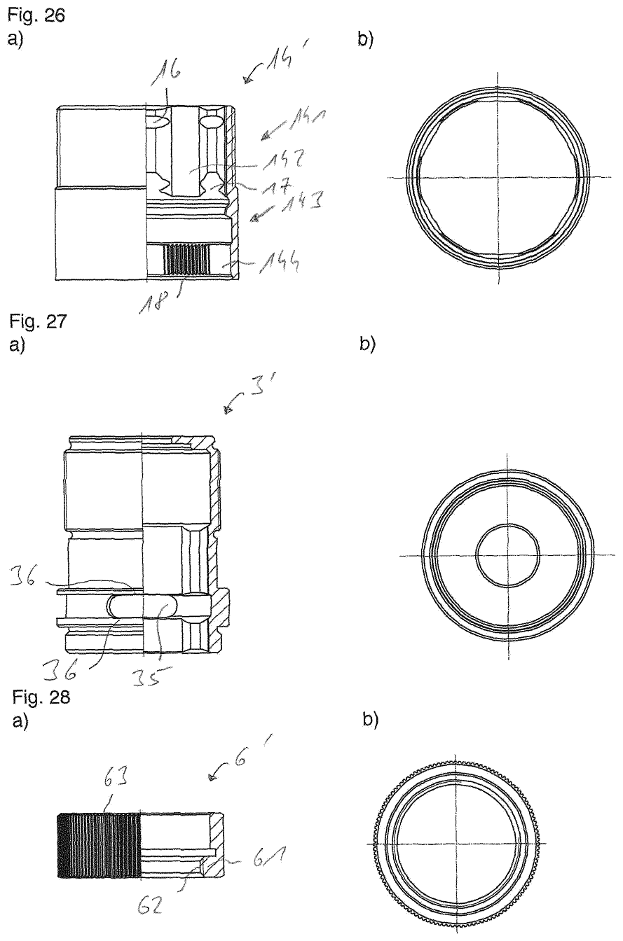

FIG. 26 shows the schematic view of the adjusting sleeve of the handle of the operating device from FIG. 16
a) in the partial section,
b) in the top view;

FIG. 27 shows the schematic view of the control cylinder of the operating device from FIG. 16
a) in the partial section,
b) in the top view;

FIG. 28 shows the schematic view of the driving piece of the control piston of the operating device from FIG. 16
a) in the partial section,
b) in the top view;

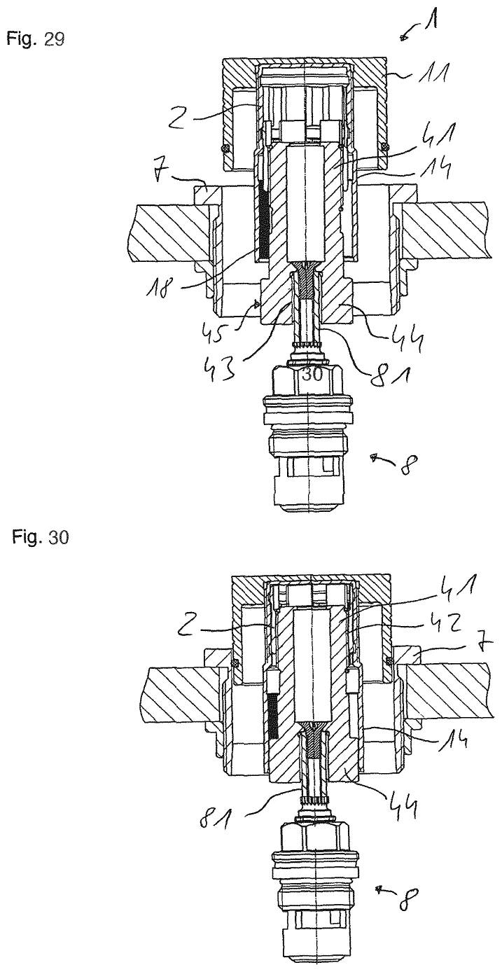

FIG. 29: shows the schematic view of a valve upper part in a third embodiment with the operating device in the adjusting position, and

FIG. 30: shows the schematic view of the valve upper part with the operating device according to FIG. 29 after the handle has been adjusted in the operating position.

The valve upper part 8 selected as the exemplary embodiment according to FIG. 1 is designed according to EP 1 696 162 A1 and has a head piece 83, which is axially penetrated by a control spindle 81, by means of which a valve body—not shown—is actuatable. An operating device is arranged on the control spindle 81 at the end, which comprises a handle 1 in which an adapter piece 2 is axially movably arranged, which accommodates a control cylinder 3, with which it is in threaded engagement, which is provided with a limiting sleeve 4 at the end and in which a control piston 5 is axially movably arranged, which is provided with a driving piece 6 at the end and which has a receptacle for the interlocking connection to the non-circular connecting portion 82 of the control spindle 81 of a valve upper part 8. Alternatively, the connecting portion of the control spindle 81 can also be cylindrical. In this case, a corotational connection, for example, by means of bonding, is required.

The handle 1 is formed from a hollow cylindrical, pot-shaped handle piece 11, which has a threaded bore 12 centrally on the inside, into which an adjusting sleeve 14 is screwed and bonded coaxially to the cylindrical side wall of the handle piece 11. Alternatively, the handle 1 can also be formed in one piece. On the outside, the handle piece 11 is provided with a seal groove 13, which accommodates an O-ring 131. The handle piece 11 and the adjusting sleeve 12 are manufactured as brass turned parts in the exemplary embodiment.

The adjusting sleeve 14 is essentially hollow cylindrical and has a first portion 141, which is adjoined by a second, expanded-diameter portion 143. The first portion 141 is provided with an external thread 15 on the outside, with which the adjusting sleeve in 14 is screwed into the threaded bore 12 in the handle piece 11 and bonded. In its inner lateral surface having a largely dodecagonal cross-section, a first, upper snap-in groove 16 and, spaced apart therefrom, a second, lower snap-in groove 17 are arranged in the first portion 141. The largely dodecagonal cross-sectional contour of the inner lateral surface of the first portion 141 is used to accommodate the adapter piece 2 in a rotationally fixed manner, the outer lateral surface of which has a dodecagonal cross-sectional contour corresponding thereto. The largely dodecagonal cross-sectional contour of the inner lateral surface of the first portion 141 and of the outer lateral surface of the adapter piece 2 is obtained by means of six rectangular flattenings 142, 21 introduced, regularly spaced apart, into the cylindrical lateral surface.

Alternatively, instead of the dodecagonal cross-sectional contour, any other non-circular, preferably polygonal contour can also be used. The second portion 143 is provided with an internal toothing 18, which extends largely over the entire inner lateral surface of the second portion 143. The inner lateral surface of the second portion 143 has a largely octagonal cross-sectional contour, which is obtained by means of four rectangular flattenings 144 introduced, regularly spaced apart, into the cylindrical inner lateral surface provided with the internal toothing 18.

The adapter piece 2 is essentially hollow cylindrical and has, as mentioned above, an outer lateral surface with a nearly dodecagonal cross-section corresponding to the inner lateral surface of the adjusting sleeve 14. In the region of each flattening 21, a rectangular recess is introduced into the adapter piece 2 on its side facing the threaded bore 12 in the handle piece 11, as a result of which, peripherally, six regularly spaced apart snap-in tabs 22 are delimited, which have radially extending, outwardly projecting snap-in lugs 23 for engaging into the snap-in grooves 16, 17 of the adjusting sleeve 14. On its inner lateral surface, the adapter piece 2 is provided with an internal thread 24. In the exemplary embodiment, the adapter piece 2 is made of plastic.

The control cylinder 3 is designed as an essentially hollow cylindrical brass turned part. On its end face facing the adapter piece 2, the control cylinder 3 has an inner-diameter-tapering projection 31, into which a step 32 is introduced on the inside. On the outside, the control cylinder 3 has an external thread 33, which extends approximately over half its length. Spaced apart from the external thread 33 is a groove 34 for accommodating an O-ring 341. The groove 34 is adjoined by two diametrically opposed, radially extending elongate bores 35, which are enclosed by two axially spaced-apart peripheral ribs 36. Between the elongate bores 35 and the external thread 33, the control cylinder 3 has a diameter-tapering projection 37 on the inside, into which four guide notches 371 are introduced, radially spaced apart around the periphery. The guide notches 371 are used for the rotationally fixed guidance of the control piston 4.

A ball 38 is introduced into each of the two elongate bores 35, the diameter of which is slightly smaller than the width of the elongate bore 35, such that this protrudes through the respective elongate bore 35 in some areas and is guided between the ribs 36 in a radially and rotatingly movable manner. A limiting sleeve 4, in which an annular spring 9 is arranged, is present on the control cylinder 3 on its end-side portion having the elongate bores 35. The limiting sleeve 4 encompasses the ribs 36 and is held by an O-ring 341. The limiting sleeve 4, together with the ribs 36, the annular spring 9, and the elongate bores 35, forms a ball cage for the two balls 38, by means of which their movement in the radial direction is limited.

The control piston 5 is designed as an essentially cylindrical brass turned part. Four flattenings 51 are introduced, radially spaced apart from one another, into its cylindrical outer lateral surface, as a result of which an essentially octagonal cross-section is formed. By means of the corners formed in this way, the control piston 5 is guided in the guide notches 371 in the control cylinder 3. Between one flattening 51 and the next, two control gates 52 are also introduced diametrically opposite one another into the outer lateral surface. A reduced-diameter projection 53, which has an external thread 531, is arranged on its end facing away from the control cylinder 3. A receptacle 54 designed in the form of an internal polygon for the control spindle 81—having an external polygon—of a valve upper part 8 extends through the projection 53. The receptacle 54 is adjoined by a tapered-inner-diameter portion 55, into which a conical bore 56 for accommodating the head of a countersinking screw 82 is centrally introduced. The tapered-inner-diameter portion 55 is adjoined by an expanded-inner-diameter portion 58, by means of which a projection 57 is formed, which acts as a spring seat for a compression spring 59.

The driving piece 6 is designed as an essentially hollow cylindrical brass turned part and has, on its end opposite the control cylinder 3, a tapered-inner-diameter portion 61, which is provided with an internal thread 62. The outer lateral surface of the driving piece 6 is provided with an external toothing 63 for engagement into the internal toothing 18 of the adjusting sleeve 14.

The adapter piece 2 is screwed with its internal thread 24 onto the external thread 33 of the control cylinder 3. Into the control cylinder 3, the control piston 5 is inserted, which is guided in the control cylinder 3 in a rotationally fixed but axially movable manner by means of its non-circular outer lateral surface designed correspondingly to the inner lateral surface of the control cylinder 3. The balls 38 protruding through the elongate bores 35 in the control cylinder 3 in some areas each engage into a control gate 52 of the control piston 5. Abutting the projection 57 on the control piston 5 is the compression spring 59, which is preloaded on its opposite side against the adjusting sleeve.

In the operating position of the handle 1 with its adjusting sleeve 14, in which the snap-in lugs 23 of the snap-in tabs 22 of the adapter piece 2 screwed onto this engage into the upper, first snap-in groove 16 of the adjusting sleeve 14, the internal toothing of the adjusting sleeve 14 is in engagement with the external toothing 63 of the driving piece 6. In this operating position, a transmission of a torque from the handle 1 onto the driving piece 6 connected to the control spindle 81 of the valve upper part 8 is made possible. The valve upper part 8 in the exemplary embodiment is designed according to EP 1 696 162 A1. It has a head piece 83, which is axially penetrated by the control spindle 81.

During the wall-side mounting of a sanitary fitting, for example, a shower fitting, the water lines are connected by the installer in the wall to a valve upper part 8 of the fitting. The valve upper part 8 regularly has a long control spindle 81, which, after completion of the wall-side work, including possible tile work, is cut to a desired length. Framing the control spindle 81, the wall passage is provided with an installation sleeve 7. The control spindle 81 is inserted with its external toothing into the receptacle 54 of the control piston 5 having an internal toothing and is fastened via a countersinking screw 82. Such an installation situation is schematically shown in FIG. 1. Due to inaccuracies during the installation of the valve upper part 8 and the cutting of the control spindle 81 to length, the handle piece 11 of the handle 1 projects considerably beyond the collar 71 of the installation sleeve 7, which, in this exemplary embodiment, has an external thread 72, which is screwed together with a locknut 73.

The handle 1 can then be moved, with its adjusting sleeve 14 longitudinally movably connected to the adapter piece 2, on the adapter piece 2 by pulling on the handle piece 11 until the snap-in lugs 23 of the snap-in tabs 22 snap into the second, lower snap-in groove 17 of the adjusting sleeve 14. In this position, the internal toothing 18 of the adjusting sleeve 14 is out of engagement with the external toothing 63 of the driving piece 6 (cf. FIG. 2). By turning the handle piece 11, the adapter piece 2, which is connected to the adjusting sleeve 14 for conjoint rotation, can then be moved via the threaded engagement with the external thread 33 of the control cylinder 3 axially relative to this (cf. FIG. 3).

When the handle 1 with its adjusting sleeve 14 is transferred from the operating position into the adjusting position, a tensile force is required to bring the snap-in lugs 23 of the snap-in tabs 22 out of first, upper snap-in groove 16, in order to bring the snap-in lugs 23 into the second, lower snap-in groove 17. In response to this tensile force, a tensile force is simultaneously generated between the control cylinder 3 and the control piston, as a result of which the balls 38 guided in the control gate 52 of the control piston 5 are pressed radially outwards against the annular spring 9. The limiting sleeve 4 prevents the balls 38 from escaping the control gate 52 (cf. FIGS. 13 and 15).

The adjusting sleeve 14 can then be moved again along the adapter piece 2 by pressing on the handle piece 11 until the snap-in lugs 23 of the snap-in tabs 22 snap into the first, upper snap-in groove 16 of the adjusting sleeve 14. The operating unit is now adjusted relative to the installation sleeve 7. It is in the operating position (cf. FIG. 4).

By pressing on the handle 1, the control cylinder 3 is moved via the adjusting sleeve 14 along the control piston 5, wherein the balls 38 roll in the control gate 52. In so doing, the balls 38 can move radially in the elongate bores 35. At the stop of the control piston 5 in the control cylinder 3, the balls 38 reach the switching portion 521 of the respective control curve 52. Once the handle 1 has been released, the control cylinder 3 is moved back due to the restoring force of the compression spring 59, as a result of which the balls 38 are moved into the holding region 522 of the control gate 52. In this position, the handle 1 is held by the balls 38. In this position, the handle 1 is in the retracted position, recessed completely into the installation sleeve 7, wherein the surfaces of the handle 1 and the collar 71 of the installation sleeve 7 lie on a plane.

When the handle 1 is pressed again, the balls 38 are moved out of the holding region 522 of the control gate 52. Once the handle 1 has been released, the control cylinder 3 is completely moved back due to the restoring force of the compression spring 59. In this operating position, the handle projects far out of the installation sleeve 7. Due to the engagement of the internal toothing 18 of the adjusting sleeve 14 with the external toothing 63 of the driving piece 6, which is connected to the control spindle 81 of the valve upper part 8 via the control piston 5, the valve upper part 8 can then be actuated by rotating the control spindle 81 via the handle 1. Once the valve upper part 8 has been actuated, pressing the handle 1 again can cause this to be retracted into the installation sleeve again.

The operating device selected as the exemplary embodiment according to FIG. 16 is highly compact. It comprises in turn a handle 1′, in which an adapter piece 2′ is axially movably arranged, which accommodates a control cylinder 3′ with which it is in threaded engagement, in which a control piston 5′ is axially movably arranged and which has a receptacle for the interlocking connection to the non-circular connecting portion 82 of the control spindle 81 of a valve upper part 8. In this exemplary embodiment, the driving piece 6′ is arranged at the end of the control cylinder 3′ and simultaneously performs the function of the limiting sleeve 4, and therefore a separate limiting sleeve is not present here. In FIGS. 16 through 28, parts of this further exemplary embodiment corresponding to parts of the first exemplary embodiment are provided with the same reference numerals.

The handle 1′ is provided with an internal thread 12, into which an adjusting sleeve 14′ is screwed and bonded. The adjusting sleeve 14′ has in turn a first portion 141, which is adjoined by a second portion 143. While the first portion 141 essentially corresponds to the first portion of the adjusting sleeve 14 of the first exemplary embodiment, the second portion 143 is substantially shorter. The second portion 143 is in turn provided with an internal toothing 18, which extends largely over its inner lateral surface, wherein the inner lateral surface of the second portion 143 has a largely octagonal cross-sectional contour, which is obtained by means of four rectangular flattenings 144 introduced, regularly spaced apart, into the cylindrical inner lateral surface provided with the internal toothing 18.

The adapter piece 2′ in this exemplary embodiment is also shorter. Instead of the regularly spaced apart snap-in tabs, a peripheral groove 22′ is arranged here, which accommodates an O-ring 25 for engagement into the snap-in grooves 16, 17 of the adjusting sleeve 14.

The control cylinder 3′ is also shorter, which is brought about, in particular, by the shorter, upper part provided with the external thread. A ball 38 is introduced in turn into each of the two elongate bores 35, the diameter of which is slightly smaller than the width of the elongate bore 35, such that this protrudes through the respective elongate bore 35 in some areas and is guided between the ribs 36 in a radially and rotatingly movable manner. Instead of the limiting sleeve, in this exemplary embodiment, the driving piece 6′ is screwed with its internal thread 62 onto the control cylinder 3′ and encompasses the ribs 36, as a result of which in turn a ball cage for the two balls 38 is delimited. The driving piece 6′ therefore simultaneously performs the task of the limiting sleeve present in the first exemplary embodiment.

The control piston 5′ essentially corresponds to the control piston 5 of the first exemplary embodiment, wherein, however, the end-side, reduced-diameter projection provided with an external thread is not present, since the driving piece 6′ in this second exemplary embodiment is not fastened on the control piston 5′, but rather on the control cylinder 3′.

The driving piece 6′ essentially corresponds to the driving piece 6 of the first exemplary embodiment, wherein a peripheral annular groove 64 for accommodating a sealing ring is simply also arranged inside adjacent to the tapered-inner-diameter portion 61.

The mode of operation of this operating device essentially corresponds to that of the operating device according to the first exemplary embodiment. In the operating position of the handle 1′ with its adjusting sleeve 14′, in which the O-ring 25—arranged in the groove 22′, acting as a snap-in element—of the adapter piece 2 screwed on this engage into the upper, first snap-in groove 16 of the adjusting sleeve 14′, the internal toothing of the adjusting sleeve 14 is in engagement with the external toothing 63 of the driving piece 6′. In this operating position, a transmission of a torque from the handle 1′ onto the driving piece 6′ connected to the control spindle 81 of the valve upper part 8 is made possible.

The handle 1′ can then in turn be moved with its adjusting sleeve 14′, which is longitudinally movably connected to the adapter piece 2′, on the adapter piece 2′ by pulling on the handle piece 11 until the O-ring 25′ snaps into the second, lower snap-in groove 17 of the adjusting sleeve 14′. In this position, the internal toothing 18 of the adjusting sleeve 14′ is out of engagement with the external toothing 63 of the driving piece 6′ (cf. FIG. 17). By turning the handle piece 11, the adapter piece 2′, which is connected to the adjusting sleeve 14′ for conjoint rotation, can then be moved via the threaded engagement with the external thread 33 of the control cylinder 3′ axially relative to this.

When the handle 1′ with its adjusting sleeve 14′ is transferred from the operating position into this adjusting position, a tensile force is required to bring the O-ring 25 out of the first, upper snap-in groove 16, in order to bring this into the second, lower snap-in groove 17. In order to ensure that the handle piece 11 cannot be brought with the O-ring 25 past the lower snap-in groove 17 due to the action of an excessive tensile force and pulled off the control piston 5′, a retaining means is arranged between the adapter piece 2′ and the adjusting sleeve 14′. For this purpose, the adjusting sleeve 14′ has a peripheral internal thread land 140 on the inside, in which an external thread land 20 arranged on the adapter piece 2′ around the outside is screwable. During mounting, the adapter piece 2′ with its external thread land 20 is screwed into the peripheral internal thread land 140 of the adjusting sleeve 14′ and then overturned. Thereafter, the external thread land 20 is located behind the internal thread land 140 as viewed in the direction of the handle part 11. As a result, the adapter piece 2′ is axially captively held in the adjusting sleeve 14′.

The adjusting sleeve 14 can then in turn be moved along the adapter piece 2′ by pressing on the handle piece 11 until the O-ring 25 snaps into the first, upper snap-in groove 16 of the adjusting sleeve 14. The operating unit is now adjusted relative to the installation sleeve 7. It is in the operating position (cf. FIG. 19).

By pressing on the handle 1′, corresponding to the operating unit according to the aforementioned first exemplary embodiment, this can be brought completely into a position retracted in the installation sleeve 7, in which it is held by the balls located in the holding region 522 of the control gate 52 of the control cylinder.

In FIG. 29, a valve upper part is shown in a third embodiment, in which a locking device is not present. An operating device is arranged on the control spindle 81 at the end, which in turn comprises a handle 1, which has a handle piece 11 and an adjusting sleeve 14 connected thereto and in which an adapter piece 2 is axially movably arranged in the above-described manner. However, the adapter piece here accommodates a coupling cylinder 41, wherein the adapter piece 2 with its internal thread 24 is screwed onto the external thread 42 of the coupling cylinder 41.

The coupling cylinder 41 has a receptacle 43 for the interlocking connection to the non-circular connecting portion 82 of the control spindle 81 of the valve upper part 8. On its end facing the valve upper part 8, the coupling cylinder 41 has an increased-diameter driving projection 44, which is provided around the outside-corresponding to the external toothing 63 of the driving piece 6 of the above-described exemplary embodiment-with an external toothing 45 for engagement into the internal toothing 18 of the adjusting sleeve 14 of the handle 1.

The handle 1 can then be moved, corresponding to the first exemplary embodiment, on the adapter piece 2 by pulling on the handle piece 11 until the snap-in lugs 23 of the snap-in tabs 22 snap into the second, lower snap-in groove 17 of the adjusting sleeve 14. In this position, the internal toothing 18 of the adjusting sleeve 14 is out of engagement with the external toothing 45 of the driving projection 44 (cf. FIG. 16). By turning the handle piece 11, the adapter piece 2 connected to the adjusting sleeve 14 for conjoint rotation can then be moved via the threaded engagement with the external thread 42 of the coupling cylinder 1 axially relative to this.

The adjusting sleeve 14 can then be moved again along the adapter piece 2 by pressing on the handle piece 11 until the snap-in lugs 23 of the snap-in tabs 22 snap into the first, upper snap-in groove 16 of the adjusting sleeve 14. The operating unit is now adjusted relative to the installation sleeve 7. The external toothing 45 of the driving projection 44 is then in engagement again with the internal toothing 18 of the adjusting sleeve 14, the threaded engagement between the adapter piece 2 and the adjusting sleeve 14 is blocked. Via the handle 1, a torque can be transmitted onto the control spindle 81. The operating device is in the operating position (cf. FIG. 17).

Of course, the blocking of the threaded engagement between the adapter piece 2 and the adjusting sleeve 14 can also take place via fixing means arranged in the handle, for example, via an axial displacement of the adjusting sleeve, as a result of which the thread of adapter piece and adjusting sleeve is bringable out of engagement. For this purpose, the adapter piece is preferably made of plastic, as a result of which it is made possible to axially pass over the thread of the adjusting sleeve. Alternatively, it is also conceivable to provide a blocking pin pressable inward from the outside, which engages into a thread.

1. A valve upper part with a head piece, which is axially penetrated by a control spindle (81), by means of which a valve body arranged in the head piece (83) is actuatable and which is connected to an operating part comprising a handle (1), wherein the handle (1) is movable relative to the head piece (83) coaxially to the control spindle (81), wherein the handle (1) is connected to the control spindle (81) via an adapter piece (2) fastened to the control spindle (81) for conjoint rotation, wherein the adapter piece (2) has an internal thread (24), which is in engagement with an external thread of the control spindle or with a component connected to the control spindle (81) and by means of which an axial position of the adapter piece (2) relative to the control spindle (81) is changeable by means of rotation.

2. The valve upper part of claim 1, wherein the handle (1) of the operating part has an adjusting sleeve (14) in which the adapter piece (2) is arranged and connected to the adjusting sleeve (14) for conjoint rotation.

3. The valve upper part of claim 2, wherein the adapter piece (2) is held in the adjusting sleeve (14) of the handle (1) in a rotationally fixed and longitudinally displaceable manner.

4. The valve upper part of claim 2, wherein the internal thread (24) of the adapter piece (2) is in engagement with an external thread (33) arranged on a control cylinder (3), which accommodates a control piston (5), which is connected to the control spindle (81).

5. The valve upper part of claim 1, wherein the handle is fixable in at least two axial positions via an arranged locking device.

6. The valve upper part of claim 5, wherein the locking device is arranged in the operating part and comprises the control piston (5), which is axially movably guided in the control cylinder (3), wherein the control cylinder (3) has a control gate (52) into which an engagement part arranged on the control cylinder (3) engages.

7. The valve upper part of claim 6, wherein the engagement part is formed by a ball (38), which is guided in the control cylinder (3) in a radially movable manner.

8. The valve upper part of claim 4, wherein the adjusting sleeve (14) surrounds the control piston (5), at least in some areas.

9. The valve upper part of claim 4, wherein a spring (59) is arranged between the control cylinder (3) and the control piston (5), which is preloaded against the control cylinder (3).

10. The valve upper part of claim 4, wherein the adjusting sleeve (14) has an internal toothing (18), which engages into an external toothing (63) arranged on the control piston (5), as a result of which the handle (1) is movably guided axially along the control piston (5).

11. The valve upper part claim 3, wherein the adapter piece (2) has snap-in lugs (23), wherein at least one snap-in groove (16, 17) is arranged inside of the adjusting sleeve (14), into which the snap-in lugs (23) are capable of snapping when the adapter piece (2) is in a defined position.

12. The valve upper part of claim 11, wherein two snap-in grooves (16, 17) are preferably arranged, axially spaced apart from one another, radially peripherally inside of the adjusting sleeve (14).

13. The valve upper part of claim 1, wherein the control spindle (81) has a non-circular connecting portion, wherein a receptacle (54) for the interlocking connection to this non-circular connecting portion, which is preferably detachably connected to the control spindle (81), is arranged on the control piston (5).

14. An operating part for the valve upper part of one claim 1.

15. A sanitary fitting with the valve upper part of one claim 1.
